(19) United States
(12) Patent Application Publication
(10) Pub. No.: US 2010/0148067 A1
(43) Pub. Date: Jun. 17, 2010

(54) BOLOMETER STRUCTURE, INFRARED DETECTION PIXEL EMPLOYING BOLOMETER STRUCTURE, AND METHOD OF FABRICATING INFRARED DETECTION PIXEL

(75) Inventors: Sang Hoon CHEON, Daejeon (KR); Ho Jun Ryu, Seoul (KR); Woo Seok Yang, Daejeon (KR); Seong Mok Cho, Daejeon (KR); Byoung Gon Yu, Daejeon (KR); Chang Auck Choi, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/507,372

(22) Filed: Jul. 22, 2009

(30) Foreign Application Priority Data
Dec. 16, 2008 (KR) 10-2008-0127604

(51) Int. Cl. G01J 5/00; C23F 1/00

(52) U.S. Cl. 250/338.1; 216/13

(57) ABSTRACT

Provided are a bolometer structure, an infrared detection pixel employing the bolometer structure, and a method of fabricating the infrared detection pixel.

The infrared detection pixel includes a substrate including a read-out integrated circuit (ROIC) and on which a reflection layer for reflecting infrared light is stacked, a bolometer structure formed to be spaced apart from the substrate and including a temperature-sensitive resistive layer, a first metal layer formed in a pattern on one surface of the temperature-sensitive resistive layer, a second metal layer formed in a pattern complementary to the pattern of the first metal layer on the other surface of the temperature-sensitive resistive layer in order to complementarily absorb infrared light, and an insulating layer formed between the temperature-sensitive resistive layer and the first metal layer, and a metal pad receiving a change in resistance of the temperature-sensitive resistive layer according to infrared light absorbed by the first metal layer and the second metal layer from the second metal layer, and transferring the change in resistance to the ROIC.

Thus, it is possible to improve responsivity, and implement a simple bolometer structure robust against stress. Consequently, process yield can be improved, and the volume, weight, price, etc., of application products can be reduced by reducing the volume of a bolometer structure.

### CROSS-REFERENCE TO RELATED APPLICATION

This application claims priority to and the benefit of Korean Patent Application No. 10-2008-0127604, filed Dec. 16, 2008, the disclosure of which is incorporated herein by reference in its entirety.

### BACKGROUND

1. Field of the Invention

The present invention relates to a bolometer structure, an infrared detection pixel employing the bolometer structure and a method of fabricating the infrared detection pixel, and more particularly to a bolometer structure having a complementary absorption layer, an infrared detection pixel of a two-level structure based on micro-electro-mechanical system (MEMS) and a method of fabricating the infrared detection pixel.

2. Discussion of Related Art

Uncooled infrared sensors detect a change in characteristic of a material according to temperature at a normal temperature of about 300 K. An uncooled infrared sensor that detects a change in resistance is referred to as a bolometer.

A bolometer-type infrared sensor includes a material that absorbs infrared light and converts the absorbed infrared light into heat, a part that thermally isolates a bolometer structure to allow increase in temperature of the structure, a part that converts a change in temperature into a change in resistance, and a part that reads the changed resistance.

To obtain an infrared image using such a bolometer-type infrared sensor, the sensor should be fabricated in the form of a two-dimensional array, and to read a signal of the sensor in the array form, a signal processing circuit and a switch should be monolithically integrated directly under the sensor structure, that is, on the same substrate. The fabricated sensor array is installed in a package that can be made vacuous, and obtains an infrared image through signal processing.

The price and performance of an uncooled bolometer infrared sensor are determined by features of an infrared-sensitive material used therein, a structure in which the material is integrated, a fabrication process of forming the structure, a technique for designing a part supporting a structure not to be mechanically weak and to be sufficiently thermally isolated, and performances of a read-out circuit that processes an output signal and performs several compensations and the package that keeps itself vacuous.

In general, a metal layer for reflecting infrared light is disposed under a bolometer structure, and a structure including a conductor having a sheet resistance of about 377 ohms/sq. is disposed at a height corresponding to a quarter of an infrared wavelength to be absorbed, such that the infrared sensor can effectively absorb infrared light. Here, a material converting a change in temperature into a change in resistance is referred to as a bolometric material, and a temperature coefficient of resistance (TCR), that is, a parameter indicating a feature of the bolometric material is defined by Equation 1.

$$T C R = \frac{dR}{R \cdot dT} , ∴ dR = T C R \cdot R \cdot dT \qquad [ Equation 1 ]$$

An infrared sensor employing a bolometer operates by obtaining an electrical signal using a resistance varying when a bolometer structure absorbs infrared light and increases in temperature. To quantify a change in temperature of such a bolometer structure, a heat balance equation is defined by Equation 2 when infrared light modulated at a frequency of ω is incident on the bolometer structure.

$$C \frac{d ( Δ T )}{d t} + G ( Δ T ) = η P = η {P}_{0} exp ( jω t ) \qquad [ Equation 2 ]$$

C: heat capacity
G: thermal conductance
η: infrared absorbance
P₀: infrared power

ΔT of Equation 2 is calculated as shown in Equation 3.

$$Δ T = \frac{η {P}_{0} exp ( jω t )}{G + jω C} = \frac{η {P}_{0}}{{G ( 1 + {ω}^{2} {τ}^{2} )}^{1 / 2}} , τ = \frac{C}{G} \qquad [ Equation 3 ]$$

Meanwhile, a magnitude Vₛ of a signal generated by infrared light with a bias current of i_{b} applied to the bolometer is defined by Equation 4.

$${V}_{S} = {i}_{b} \cdot Δ R = {i}_{b} \cdot T C R \cdot R \cdot dT = \frac{{i}_{b} T C R \cdot R \cdot η {P}_{0}}{{G ( 1 + {ω}^{2} {τ}^{2} )}^{1 / 2}} \qquad [ Equation 4 ]$$

Responsivity to infrared light is derived from Equation 4 as shown in Equation 5.

$${V}_{} ≡ \frac{{V}_{S}}{{P}_{0}} = \frac{{i}_{b} T C R \cdot R \cdot η}{{G ( 1 + {ω}^{2} {τ}^{2} )}^{1 / 2}} = \frac{{V}_{b} \cdot T C R \cdot η}{{G ( 1 + {ω}^{2} {τ}^{2} )}^{1 / 2}} \qquad [ Equation 5 ]$$

Meanwhile, the most important characteristic of an infrared sensor is noise equivalent temperature difference (NETD). This characteristic is obtained in consideration of signal fluctuation caused by noise, and defined as a ratio of a magnitude of a signal generated by infrared light to a magnitude of a noise signal, which is shown in Equation 6.

$$N E T {D}_{bolometer} = \frac{{V}_{n}}{{V}_{} \frac{d P}{d T}} \qquad [ Equation 6 ]$$

P denotes power of infrared light generated at a temperature T in consideration of an optical system and an infrared filter. In other words, the denominator of Equation 6 denotes a change in signal of the bolometer when the temperature T varies by one degree, and thus NETD has a unit of temperature (mK).

Vₙ is the sum of noise of the bolometer itself and circuit noise added through a read-out circuit. Only a specific band of the noise of the bolometer itself is passed by a frequency response characteristic of a system and denoted in a final output. Noise of the bolometer includes Johnson noise, which has a uniform level all over the frequency domain, and 1/f noise (pink noise), which has a level reduced according to frequency. The noise voltage Vₙ is calculated as shown in Equation 7. 1/f noise increases according to bias.

$$\begin{matrix}{V}_{n}^{2} = {\int }_{{f}_{1}}^{{f}_{2}} ( 4 KTR + {V}_{b}^{2} \cdot {k}^{′2} \frac{ρ}{wlt} \frac{1}{f} ) d f \\ = 4 KTR \cdot ( {f}_{2} - {f}_{1} ) + {V}_{b}^{2} \cdot {k}^{′2} \frac{ρ}{wlt} \cdot ln ( \frac{{f}_{2}}{{f}_{1}} )\end{matrix} \qquad [ Equation 7 ]$$

k′ denotes a unique 1/f characteristic constant that the material of a resistant body has, ρ denotes resistivity, and wlt denotes a volume of a material through which current flows. f₁ is determined to have a value of ¼_{Tstate} according to the time when the system is reset, and f2 is determined to have a value of ½Δτ according to the length of a pulse by which bias is applied to the bolometer. Thus, NETD may be expressed by Equation 8.

$$\begin{matrix}N E T {D}_{bolometer} = \frac{{V}_{n}}{{V}_{} \frac{d P}{d T}} \\ = \sqrt{\frac{4 KTR \cdot ( {f}_{2} - {f}_{1} ) + {V}_{b}^{2} \cdot {k}^{′2} \frac{ρ}{wlt} \cdot ln ( \frac{{f}_{2}}{{f}_{1}} )}{\frac{{V}_{b} \cdot T C R \cdot η}{{G ( 1 + {ω}^{2} {τ}^{2} )}^{1 / 2}} \cdot \frac{d P}{d T}}} ,\end{matrix} \\ τ = \frac{C}{G} \qquad [ Equation 8 ]$$

When a material of a bolometer structure, a laminated structure, etc., are changed to enhance the characteristics of the bolometer, it should be checked whether NETD, the final goal is improved or not. This is because most efforts for enhancing characteristics deteriorate the noise characteristic Vₙ while improving an infrared responsivity R_{V}, or deteriorate the infrared responsivity R_{V} while improving the noise characteristic Vₙ. In most cases, a bias voltage V_{b} is high enough, and thus Equation 9 is derived from Equation 8.

$$N E T {D}_{bolometer} ∝ \frac{{k}^{′} \sqrt{\frac{ρ}{wlt} ln ( \frac{{f}_{2}}{{f}_{1}} )}}{\frac{T C R \cdot η}{{G ( 1 + {ω}^{2} {τ}^{2} )}^{1 / 2}}} , \\ τ = \frac{C}{G} \qquad [ Equation 9 ]$$

As can be seen from Equation 9, to enhance characteristics by improving the material of a resistant body of a bolometer, a thin film having high TCR, low resistivity, and low k′ is required. The representative material is vanadium oxide (VO_{X}). To enhance the characteristics, not by improving the resistant material, but by designing the structure, is somewhat complicated. When an image is implemented, f₁ and f₂ are determined by a whole array size and frame rate, and so is τ. In the case of a frame rate being 30 frames per second (fps), τ should be 10 ms or less to implement a moving image.

When τ is fixed, along with the characteristics of the material of the resistant body, NETD may be expressed by Equation 10.

$$N E T {D}_{bolometer} ∝ \frac{G}{η \cdot \sqrt{wlt}} , \\ τ = \frac{C}{G} \qquad [ Equation 10 ]$$

When characteristic enhancement is tried by structure design, influence on the respective parameters of Equation 10 should be accurately analyzed. The thermal conductance G should be reduced to improve performance, and in this case, the heat capacity C should also be reduced to maintain τ. To increase infrared absorbance, an area absorbing infrared light should be increased by increasing the fill-factor of the structure, and resonance should be caused by disposing the structure at a height corresponding to a quarter of a wavelength to be absorbed. When the sheet resistance of the structure is 377 ohms/sq., the structure theoretically has the peak infrared absorbance, and thus a method of implementing the sheet resistance is also required.

FIGS. 1A to 1C are views showing the structure of a conventional bolometer infrared sensor. FIG. 1A is a plan view of the conventional bolometer infrared sensor, FIG. 1B is a cross-sectional view taken along line AA′ of FIG. 1A, and FIG. 1C is a cross-sectional view taken along line BB′ of FIG. 1A.

Referring to FIGS. 1A to 1C, the conventional bolometer infrared sensor includes a bolometer structure 100, a substrate 102 on which a read-out integrated circuit (ROIC) (not shown) is formed, an insulating layer 104 and an infrared reflecting layer 106 sequentially stacked on the substrate 102, and supports 120 supporting the bolometer structure 100 and transferring a signal.

The bolometer structure 100 is spaced apart from the entire substrate by a distance corresponding to a quarter of an infrared wavelength λ to be absorbed. The bolometer structure 100 includes a first insulating layer 108, a metal layer 110 functioning as an electrode, a temperature-sensitive resistive layer 114, a second insulating layer 116, an infrared-absorbing metal layer 118, and a third insulating layer 119.

The above-mentioned structure can be easily implemented by separately depositing the infrared-absorbing metal layer 118 which absorbs infrared light, and is most frequently used in bolometer infrared sensors. However, the structure requires an additional process and increases the heat capacity of the bolometer structure 110, thereby deteriorating overall NETD.

Meanwhile, it is also problematic when the bias voltage V_{b} is not high enough in Equation 8. When amorphous silicon (a-Si) is used as the material of the resistive body, the obtainable minimum resistivity is not small, and thus a resistance R becomes very large. In this case, Johnson noise is greater than 1/f noise. To solve this problem, a bolometer infrared sensor having a new structure has been developed, which is shown in FIGS. 2A to 2C.

FIGS. 2A to 2C are views showing the structure of a conventional bolometer infrared sensor. FIG. 2A is a plan view of the conventional bolometer infrared sensor, and FIGS. 2B and 2C are cross-sectional views taken along line AA′ of FIG. 2A.

Referring to FIGS. 2A and 2B, the conventional bolometer infrared sensor includes a bolometer structure 100, a substrate 102 on which a ROIC (not shown) is formed, an insulating layer 104 and an infrared reflecting layer 106 sequentially stacked on the substrate 102, and supports 120 supporting the bolometer structure 100 and transferring a signal.

The bolometer structure 100 is spaced apart from the entire substrate by a distance corresponding to a quarter of an infrared wavelength λ to be absorbed. The bolometer structure 100 includes a first insulating layer 108, a metal layer 110 functioning as an electrode, a temperature-sensitive resistive layer 114, and a second insulating layer 116.

Compared with the conventional structure of FIGS. 1A to 1C, the above-described structure has a difference in that the infrared-absorbing metal layer 118 is not formed, and the metal layer 110 functioning as an electrode is formed in an interdigitated shape to absorb infrared light.

In this way, the problem of the conventional structure of FIG. 1, that is, the complicated process, can be removed, and performance deterioration of the structure can be somewhat prevented by reducing the resistance R. However, the effective volume wlt of 1/f noise is reduced, and thus overall noise may actually increase.

FIG. 2C shows basically the same structure as FIG. 2B from which the insulating layers 116 and 108 of the bolometer structure 100 are removed. This is intended to improve infrared responsivity, but may cause severe deformation.

Meanwhile, the structure of FIG. 2 can use an infrared-sensitive material whose resistivity is large such as a-Si. On the other hand, when an infrared-sensitive material whose resistivity is not large is used, the structure of FIG. 2 is not useful. This is because the infrared-sensitive material can absorb infrared light, and the interdigitated-shape structure is not required due to small resistance.

Also, resistance and infrared absorbance are determined according to the shape of an electrode. However, it is impossible to separately design the structure of FIG. 2 for the two characteristics, and thus one of the characteristics cannot but deteriorate. More specifically, an area occupied by the electrode should be increased to increase infrared absorbance, and in this case, resistance may become too small to match the ROIC. Also, when the electrode is designed such that the resistance matches the ROIC, infrared absorbance may deteriorate.

To solve the problem, a technique for separately determining the two characteristics, that is, resistance and infrared absorbance has been developed, which will be described below with reference to FIG. 3.

FIGS. 3A and 3B are views showing the structure of a conventional bolometer infrared sensor. FIG. 3A is a plan view of the conventional bolometer infrared sensor, and FIG. 3B is a cross-sectional view taken along line AA′ of FIG. 3A.

Referring to FIGS. 3A and 3B, the conventional bolometer infrared sensor includes a bolometer structure 100, a substrate 102 on which a ROIC (not shown) is formed, an insulating layer 104 and an infrared reflecting layer 106 sequentially stacked on the substrate 102, and supports 120 supporting the bolometer structure 100 and transferring a signal.

The bolometer structure 100 is spaced apart from the entire substrate by a distance corresponding to a quarter of an infrared wavelength λ to be absorbed. The bolometer structure 100 includes a first insulating layer 108, a metal layer 110 functioning as an electrode, a temperature-sensitive resistive layer 114, a part 130 connecting the metal layer 110 and the temperature-sensitive resistive layer 114, and a part 140 separating the metal layer 110.

In the bolometer infrared sensor having the above-described structure, resistance is determined by the area and position of the part 130 connecting the metal layer 110 and the temperature-sensitive resistive layer 114, and infrared light is absorbed by the entire area except the part 140 separating the metal layer 110.

Thus, compared with the conventional structure of FIGS. 2A to 2C, the structure of FIGS. 3A and 3B has an advantage in that an interdigitated-shape part by which resistance is determined can be designed independently from an area absorbing infrared light.

However, the structure of FIGS. 3A and 3B should be formed not to disconnect the metal layer 110 functioning as an electrode, and thus infrared light cannot be absorbed by the entire area of the bolometer structure 100. Also, since one insulating layer should be added, the heat capacity and thermal conductance of the bolometer structure 100 are reduced. Furthermore, the structure of FIG. 3B does not have passivation layers supporting upper and lower surfaces. Thus, the symmetry of stress is disturbed such that the bolometer structure 100 may easily deform, and when passivation layers for supporting the upper and lower surfaces are added, responsivity deteriorates.

Consequently, a technique that involves a simple process, causes little deformation resulting from stress, and can improve the responsivity of a bolometer is required.

### SUMMARY OF THE INVENTION

The present invention is directed to providing a bolometer structure for improving responsivity of a bolometer by expanding an infrared-absorbing area, an infrared detection pixel employing the bolometer structure, and a method of fabricating the infrared detection pixel.

The present invention is also directed to providing a bolometer structure implemented as a symmetrically laminated structure and thus insensitive to stress, an infrared detection pixel employing the bolometer structure, and a method of fabricating the infrared detection pixel.

The present invention is also directed to providing a method of reducing the thickness of a bolometer structure in order to improve responsivity of a bolometer and process yield.

One aspect of the present invention provides a bolometer structure including: a temperature-sensitive resistive layer; a first metal layer formed in a pattern on one surface of the temperature-sensitive resistive layer and absorbing infrared light; a second metal layer formed in a pattern complementary to the pattern of the first metal layer on the other surface of the temperature-sensitive resistive layer in order to complementarily absorb infrared light, and outputting a change in resistance of the temperature-sensitive resistive layer to outside; and an insulating layer formed between the temperature-sensitive resistive layer and the first metal layer.

Another aspect of the present invention provides an infrared detection pixel including: a substrate including a read-out integrated circuit (ROIC) and on which a reflection layer for reflecting infrared light is stacked; a bolometer structure formed to be spaced apart from the substrate and including a temperature-sensitive resistive layer, a first metal layer formed in a pattern on one surface of the temperature-sensitive resistive layer, a second metal layer formed in a pattern complementary to the pattern of the first metal layer on the other surface of the temperature-sensitive resistive layer in order to complementarily absorb infrared light, and an insulating layer formed between the temperature-sensitive resistive layer and the first metal layer; and a metal pad for receiving a change in resistance of the temperature-sensitive resistive layer according to infrared light absorbed by the first metal layer and the second metal layer, from the second metal layer, and transferring it to the ROIC.

Still another aspect of the present invention provides a method of fabricating an infrared detection pixel, including: preparing a substrate including a ROIC and on which a metal pad and an infrared reflecting layer are formed; depositing a sacrificial layer on the substrate; forming a bolometer structure including a first metal layer and a second metal layer having complementary patterns on both surfaces of a temperature-sensitive resistive layer, on the sacrificial layer; and etching the sacrificial layer.

The forming the bolometer structure includes: depositing the first metal layer for absorbing infrared light on the sacrificial layer; forming an insulating layer on the first metal layer; etching the first metal layer and the insulating layer and forming a predetermined pattern; depositing a temperature-sensitive resistive layer on the sacrificial layer and the insulating layer; depositing the second metal layer for infrared light absorption and connection with the metal pad, on the temperature-sensitive resistive layer; and etching the second metal layer to have a pattern complementary to the pattern of the first metal layer.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIGS. 1A to 1C, 2A to 2C, and 3A and 3B show structures of conventional bolometer infrared sensors;

FIGS. 4A to 4C show structures of an infrared detection pixel according to an exemplary embodiment of the present invention;

FIGS. 5A to 5E illustrate a process of fabricating an infrared detection pixel according to an exemplary embodiment of the present invention; and

FIGS. 6A to 6C show a structure of an infrared detection pixel according to another exemplary embodiment of the present invention.

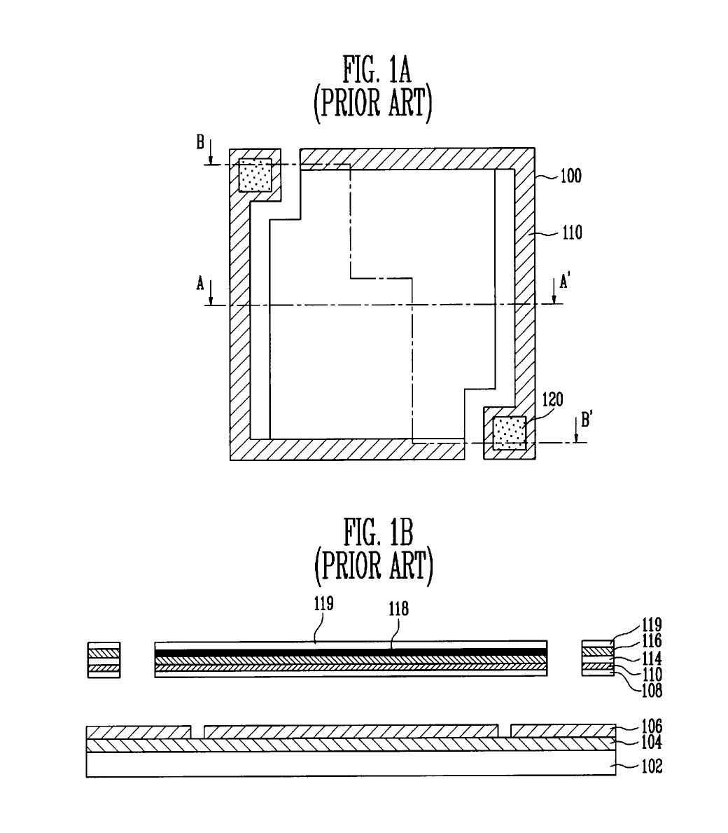

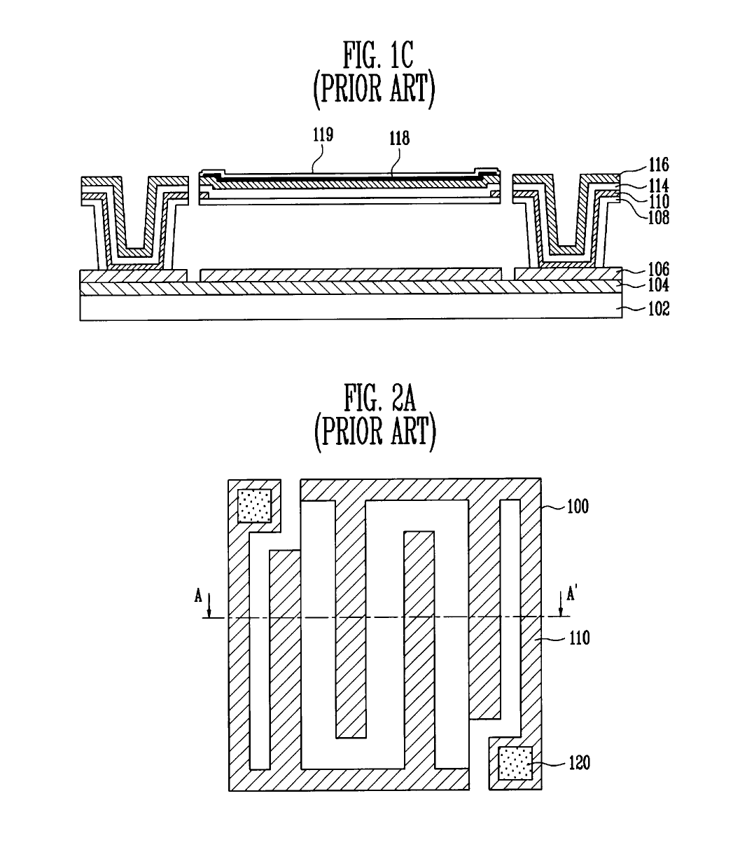

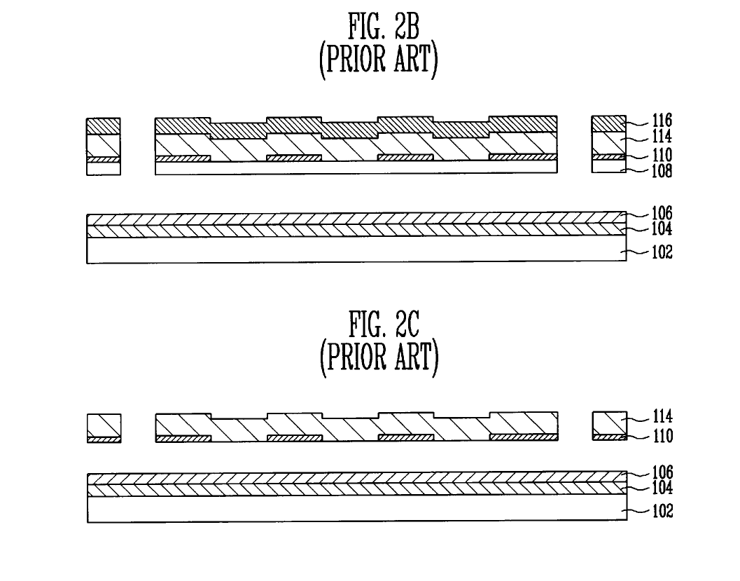

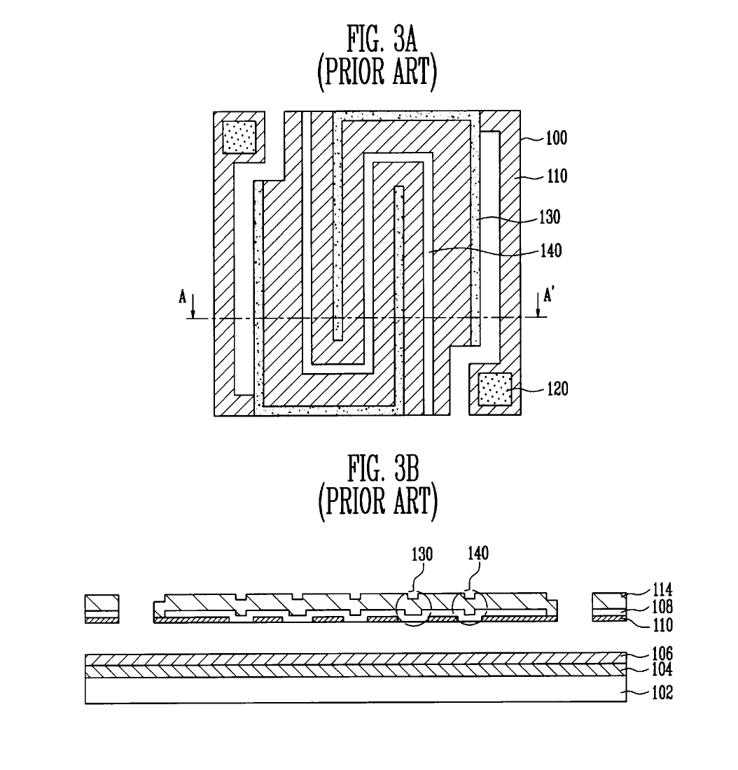

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention.

As described above, a conventional bolometer infrared sensor has a problem in that when a metal layer functioning as an absorption layer is additionally formed, an additional process is required, and overall performance deteriorates due to high heat capacity. Also, a conventional interdigitated-shape structure not requiring a metal layer functioning as an absorption layer has problems in that noise increases due to reduction in the effective volume, it is vulnerable to stress due to the asymmetry of the bolometer structure, characteristics such as thermal conductance deteriorate, and so on.

Accordingly, to solve to these problems, exemplary embodiments of the present invention provide a bolometer structure that improves infrared absorbance by forming an infrared-absorbing layer and a metal layer having a pattern complementary to the pattern of the infrared-absorbing layer and functioning as an electrode on both surfaces of a temperature-sensitive resistive layer, undergoes little deformation resulting from stress, and has a small thickness overall to reduce heat capacity and improve responsivity and process yield, an infrared detection pixel employing the bolometer structure, and a method of fabricating the infrared detection pixel.

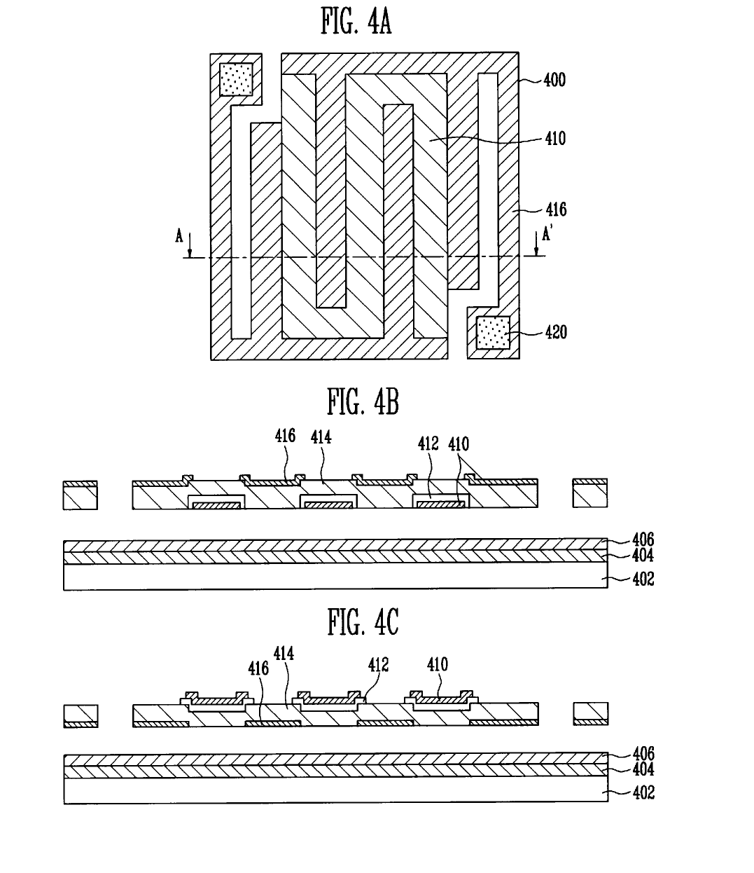

FIG. 4A is a plan view of an infrared detection pixel according to an exemplary embodiment of the present invention, and FIG. 4B is a cross-sectional view taken along line AA′ of FIG. 4A. Referring to FIGS. 4A and 4B, the infrared detection pixel according to an exemplary embodiment of the present invention includes a substrate 402, a passivation layer 404, an infrared reflecting layer 406, and a bolometer structure 400.

On the substrate 402 according to an exemplary embodiment of the present invention, a read-out integrated circuit (ROIC) (not shown) receiving a signal from the bolometer structure 400 is formed. The ROIC may be implemented using a complementary metal oxide semiconductor (CMOS) through a semiconductor integrated circuit (IC) fabrication process, etc. A p-type silicon substrate or a substrate in which an n-well is formed may be used as the substrate 402.

Electrode pads 420 for connecting an electrode (not shown) formed in the ROIC and the bolometer structure 400 are formed on the substrate 402.

The passivation layer 404 for leveling and protecting the substrate 402 is formed on the substrate 402 excluding parts for the electrode pads 420. The passivation layer 404 may be formed of a silicon nitride (Si₃N₄) layer, etc.

The infrared reflecting layer 406 for reflecting infrared light is formed on the passivation layer 404, and may be omitted according to the designer's intention.

The bolometer structure 400 according to an exemplary embodiment of the present invention includes a temperature-sensitive resistive layer 414, a first metal layer 410 and a second metal layer 416 formed in complementary patterns on the both surfaces of the temperature-sensitive resistive layer 414, and an insulating layer 412 formed between the temperature-sensitive resistive layer 414 and the first metal layer 410. The bolometer structure 400 may be spaced apart from the infrared reflecting layer 406 formed on the substrate 402 by a distance corresponding to a quarter of an infrared wavelength λ in order to absorb infrared light in a wavelength band of 10 um.

The temperature-sensitive resistive layer 414 according to an exemplary embodiment of the present invention is formed of a material whose resistance varies according to temperature. An infrared image can be obtained by detecting a change in resistance of the material. The temperature-sensitive resistive layer 414 may be formed of amorphous silicon (a-Si), silicon germanium (SiGe), vanadium oxide (VO_{X}), etc., by plasma enhanced chemical vapor deposition (PECVD), sputtering, etc., and may have a thickness of 500 to 2000 Å.

The first metal layer 410 according to an exemplary embodiment of the present invention is formed in a specific pattern on one surface of the temperature-sensitive resistive layer 414, and absorbs infrared light incident from the infrared reflecting layer 406.

The second metal layer 416 according to an exemplary embodiment of the present invention is formed in a pattern complementary to the pattern of the first metal layer 410 on the other surface of the temperature-sensitive resistive layer 414, that is, a surface on which the first metal layer 410 is not formed. Accordingly, infrared light not absorbed by the first metal layer 410 is complementarily absorbed by the second metal layer 416. Also, the second metal layer 416 functions as an electrode, and transfers a change in resistance of the bolometer structure 400 to the ROIC through the electrode pads 420.

The pattern of the second metal layer 416 should be designed in consideration of an area for obtaining a desired resistance. When the pattern of the second metal layer 416 is determined, the pattern of the first metal layer 410 complementary to the pattern of the second metal layer 416 is automatically determined.

In an exemplary embodiment described with reference to FIGS. 4A to 4C, the first metal layer 410 and the second metal layer 416 have interdigitated-shape patterns. However, the patterns may vary in shape according to the designer's intention, and are not limited to the interdigitated shape.

Meanwhile, the first metal layer 410 and the second metal layer 416 may be formed of titanium (Ti), titanium nitride (TiN), nickel chromium (NiCr), etc., by sputtering, etc. The first metal layer 410 and the second metal layer 416 may have a thickness of 100 to 500 Å.

As described above, according to an exemplary embodiment of the present invention, the first metal layer 410 and the second metal layer 416 are formed in complementary patterns on the both surfaces of the temperature-sensitive resistive layer 414. Thus, infrared light is absorbed by the entire area of the bolometer structure 400, and the characteristic can be improved.

Also, since the complementary patterns are symmetrically formed on the both surfaces of the temperature-sensitive resistive layer 414, it is possible to prevent deformation of the bolometer structure 400 caused by stress such as temperature variation.

Further, since the bolometer structure 400 is robust against stress, it is not necessary to form additional passivation layers on the upper and lower surfaces of the bolometer structure 400 to prevent deformation, and the process is simplified.

Meanwhile, the electrode pads 420 according to an exemplary embodiment of the present invention are formed on the ROIC, and serve to transfer a signal between the bolometer structure 400 and the ROIC.

The insulating layer 412 according to an exemplary embodiment of the present invention is formed between the temperature-sensitive resistive layer 414 and the first metal layer 410, and serves to prevent unnecessary electrical conduction to the first metal layer 410. The insulating layer 412 may be formed by surface treatment, such as oxidation of the surface of the first metal layer 410, PECVD, etc. In the case of surface treatment such as oxidation, the first metal layer 410 may be formed of one of Ti, TiN, aluminum (Al) and NiCr, and then oxidized such that the insulating layer 412 is formed of titanium oxide (TiO_{X}), aluminum oxide (AlO_{X}), chromium oxide (CrO_{X}), etc. On the other hand, in the case of PECVD, the insulating layer 412 may be formed of Si₃N₄, silicon dioxide (SiO₂), etc.

Meanwhile, FIG. 4C is also a cross-sectional view taken along line AA′. For processing convenience, the structure of FIG. 4C is designed differently from the structure of FIG. 4B, in that the positions of the first metal layer 410 and the second metal layer 416 are exchanged. The elements function in the same way.

Still, as described above, the first metal layer 410 may be oxidized to form the insulating layer 412 when the insulating layer 412 is formed on the first metal layer 410 as shown in FIG. 4B, but the insulating layer should be formed by a general deposition method such as PECVD when the insulating layer 412 is formed under the first metal layer 410 as shown in FIG. 4C.

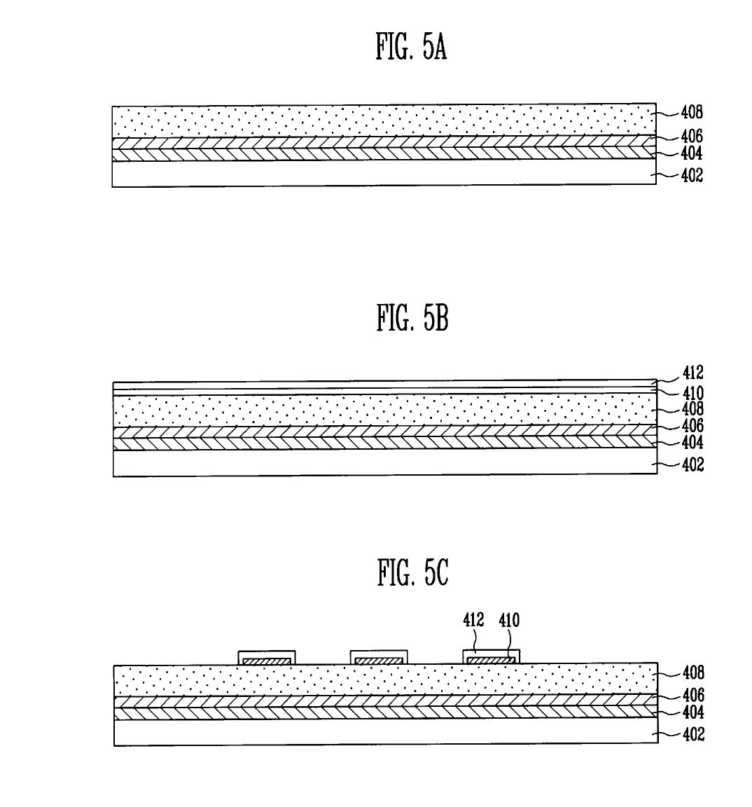

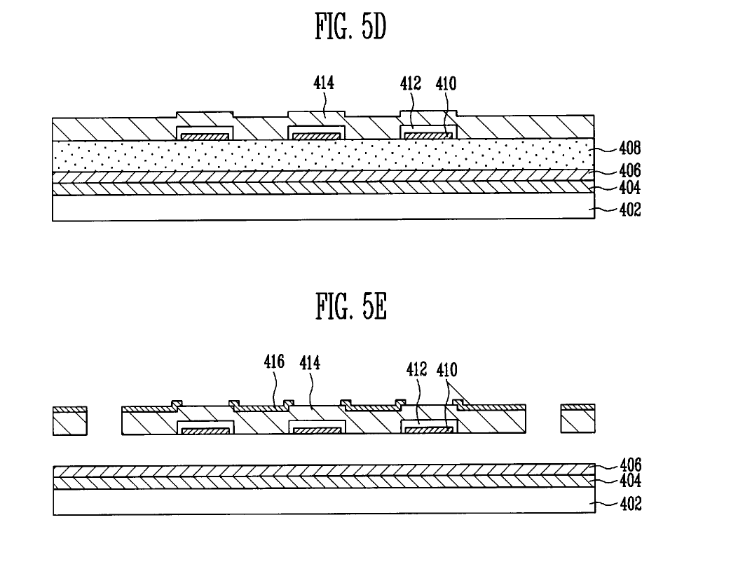

FIGS. 5A to 5E illustrate a process of fabricating an infrared detection pixel according to an exemplary embodiment of the present invention. The process of fabricating an infrared detection pixel having a layer stacking sequence as shown in FIG. 4B according to an exemplary embodiment of the present invention will be described in detail with reference to FIGS. 5A to 5E.

For convenience, assuming that a ROIC is formed on the substrate 402 of the infrared detection pixel according to an exemplary embodiment of the present invention, and the passivation layer 404, the infrared reflecting layer 406, and the electrode pads 420 for connection with bolometer structure 400 are formed in advance on the substrate 402, the process will be described below with parts of the drawings involved with known art omitted according to necessities. As mentioned above, the substrate 402 on which the passivation layer 404 is not formed may be used according to the designer's intention.

Since the present invention is directed to simplifying the bolometer structure 400 and improving the characteristics and process yield, and to the symmetrically laminated structure of the bolometer structure 400 which is less sensitive to stress, a detailed description about connection between the electrode pads 420 and the bolometer structure 400 will be omitted.

First, as shown in FIG. 5A, the substrate 402 including a ROIC is prepared. As described above, the electrode pads 420, the passivation layer 404 and the infrared reflecting layer 406 are formed on the substrate 402. When the substrate 402 is prepared, a sacrificial layer 408 is formed on the substrate 402.

The sacrificial layer 408 is intended to form the bolometer structure 400 to be spaced apart from the substrate 402 by a predetermined distance later. The distance between the substrate 402 and the bolometer structure 400 is determined by the thickness of the formed sacrificial layer 408.

As mentioned above, in order to facilitate 10 μm-band infrared absorption by maximizing resonance, the sacrificial layer 408 should be formed such that the distance between the infrared reflecting layer 406 and the bolometer structure 400 becomes a quarter of an incident infrared wavelength λ. Thus, the sacrificial layer 408 may be formed to a thickness of 2.5 to 3.0 μm. The sacrificial layer 408 may be formed of polyimide by spin-coating, etc.

Subsequently, as shown in FIG. 5B, the first metal layer 410 for absorbing infrared light and the insulating layer 412 are formed on the sacrificial layer 408.

The first metal layer 410 may be formed of Ti, TiN, NiCr, etc., by sputtering, etc., and may be formed to a thickness of 100 to 500 Å.

The insulating layer 412 serves to prevent unnecessary electrical conduction between the temperature-sensitive resistive layer 414 and the first metal layer 410. The insulating layer 412 may be formed by surface treatment, such as oxidation of the surface of the first metal layer 410, PECVD, etc. In the case of surface treatment such as oxidation, the first metal layer 410 may be formed of one of Ti, TiN, Al and NiCr, and then oxidized such that the insulating layer 412 is formed of TiO_{X}, AlO_{X}, CrO_{X}, etc. On the other hand, in the case of PECVD, the insulating layer 412 may be formed of Si₃N₄, SiO₂, etc.

Subsequently, as shown in FIG. 5C, the first metal layer 410 and the insulating layer 412 are etched to have predetermined patterns.

As described above, the first metal layer should be etched to have a pattern complementary to a pattern of the second metal layer 416, which is designed to have an area for obtaining a desired resistance. Also, although the patterns may have various shapes according to the designer's intention, in this exemplary embodiment, they have an interdigitated shape. Needless to say, the present invention is not limited to the interdigitated-shape patterns.

Meanwhile, as shown in FIGS. 5B and 5C, the first metal layer 410 and the insulating layer 412 may be formed and then etched to have the patterns at once, or the insulating layer 412 may be formed after the first metal layer 410 is formed and etched to have the predetermined pattern.

Subsequently, as shown in FIG. 5D, the temperature-sensitive resistive layer 414 is formed to cover the entire structure resulting from the etching process. The temperature-sensitive resistive layer 414 may be formed of a-Si, SiGe, VO_{X}, etc., by PECVD, sputtering, etc, and may have a thickness of 500 to 2000 Å.

Subsequently, as shown in FIG. 5E, the second metal layer 416 is deposited on the temperature-sensitive resistive layer 414 and then etched to have the pattern complementary to the pattern of the first metal layer 410.

The second metal layer 416 may be formed of Ti, TiN, NiCr, etc., by sputtering, etc., and may have a thickness of 100 to 500 Å.

In this process, the sacrificial layer 408 is removed by etching.

Although not shown in the drawings, additional passivation layers may be formed on the upper and lower surfaces the bolometer structure 400 to protect it from physical deformation such as a scratch. At this time, nitride layers may be used as the passivation layers, and may have a thickness of 100 to 1000 Å.

For processing convenience, as shown in FIG. 4C, the first metal layer 410 and the second metal layer 416 may be formed in the exchanged layer stacking orders.

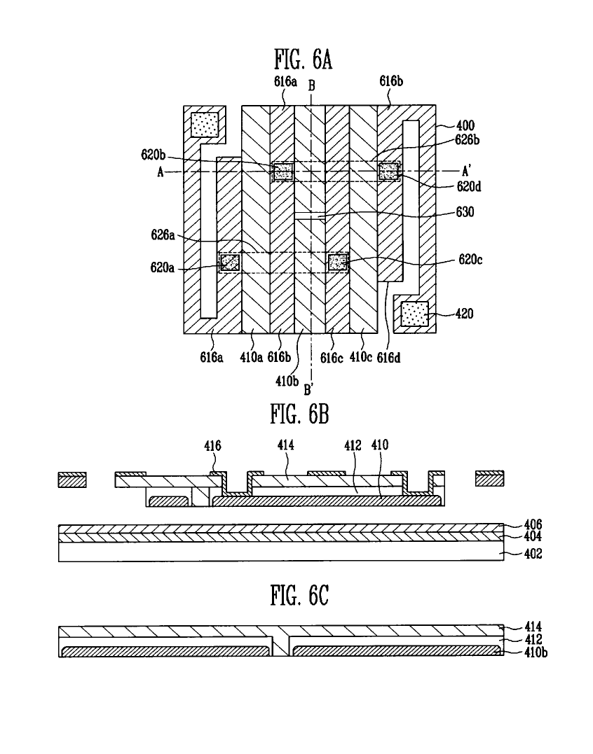

FIGS. 6A to 6C show a structure of an infrared detection pixel according to another exemplary embodiment of the present invention. FIG. 6A is a plan view of the infrared detection pixel, FIG. 6B is a cross-sectional view taken along line AA′ of FIG. 6A, and FIG. 6C is a cross-sectional view taken along line BB′ of FIG. 6A.

The structure of FIGS. 6A to 6C is intended to improve a noise characteristic by equalizing the electric field generated from a bolometer structure 400.

Referring to FIGS. 6A and 6B, a second metal layer 416 includes four separate electrodes 616a, 616b, 616c and 616d, and vias 620a, 620b, 620c and 620d are formed to penetrate the electrodes 616a, 616b, 616c and 616d, respectively.

An extension 626a connected with a first metal layer 410b is formed between the vias 620a and 620c, thereby connecting the first electrode 616a and the third electrode 616c. Thus, a voltage applied to the third electrode 616c is the same as that applied to the first electrode 616a.

Likewise, an extension 626b connected with the first metal layer 410b is formed between the vias 620b and 620d, thereby connecting the second electrode 616b and the fourth electrode 616d. Thus, a voltage applied to the fourth electrode 616d is the same as that applied to the second electrode 616b.

Meanwhile, as shown in FIG. 6C, a separator 630 separating the first metal layer 410b is formed in a region in which the first metal layer 410b is formed.

The above-described structure according to an exemplary embodiment of the present invention can equalize the electric field generated from the bolometer structure 400.

As described above, exemplary embodiments of the present invention can exhibit improved responsivity, and implement a simple bolometer structure robust against stress. Accordingly, process yield can be improved, and the volume, weight, price, etc., of application products can be reduced by reducing the volume of the bolometer structure.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A bolometer structure, comprising:
a temperature-sensitive resistive layer;
a first metal layer formed in a pattern on one surface of the temperature-sensitive resistive layer and absorbing infrared light;
a second metal layer formed in a pattern complementary to the pattern of the first metal layer on the other surface of the temperature-sensitive resistive layer in order to complementarily absorb infrared light, and outputting a change in resistance of the temperature-sensitive resistive layer to outside; and
an insulating layer formed between the temperature-sensitive resistive layer and the first metal layer.

2. The bolometer structure of claim 1, wherein the first metal layer and the second metal layer are formed of one of titanium (Ti), titanium nitride (TiN), and nickel chromium (NiCr).

3. The bolometer structure of claim 1, wherein the insulating layer is formed of one of titanium oxide (TiO_{X}), aluminum oxide (AlO_{X}), chromium oxide (CrO_{X}), silicon nitride (Si₃N₄), and silicon dioxide (SiO₂).

4. The bolometer structure of claim 1, further comprising:
a passivation layer formed on an upper or lower surface of the bolometer structure.

5. The bolometer structure of claim 1, wherein the temperature-sensitive resistive layer is formed of one of amorphous silicon (a-Si), silicon germanium (SiGe), and vanadium oxide (VO_{X}).

6. The bolometer structure of claim 1, wherein the first and second metal layers are formed in an interdigitated shape.

7. The bolometer structure of claim 1, wherein the second metal layer includes: first to fourth electrodes sequentially arranged and separated from each other; vias formed in the first to fourth electrodes; and extensions connecting the vias in order to electrically connect the first electrode with the third electrode, and the second electrode with the fourth electrode, and
a separator is formed to electrically separate the first metal layer disposed between the second electrode and the third electrode, so that an electric field generated from the bolometer structure is equalized.

8. An infrared detection pixel, comprising:
a substrate including a read-out integrated circuit (ROIC) and on which a reflection layer for reflecting infrared light is stacked;
a bolometer structure formed to be spaced apart from the substrate and including a temperature-sensitive resistive layer, a first metal layer formed in a pattern on one surface of the temperature-sensitive resistive layer, a second metal layer formed in a pattern complementary to the pattern of the first metal layer on the other surface of the temperature-sensitive resistive layer in order to complementarily absorb infrared light, and an insulating layer formed between the temperature-sensitive resistive layer and the first metal layer; and
a metal pad receiving a change in resistance of the temperature-sensitive resistive layer according to infrared light absorbed by the first metal layer and the second metal layer from the second metal layer, and transferring the change in resistance to the ROIC.

9. A method of fabricating an infrared detection pixel, comprising:
preparing a substrate including a read-out integrated circuit (ROIC) and on which a metal pad and an infrared reflecting layer are formed;
depositing a sacrificial layer on the substrate;
forming a bolometer structure including a first metal layer and a second metal layer having complementary patterns on both surfaces of a temperature-sensitive resistive layer, on the sacrificial layer; and
etching the sacrificial layer.

10. The method of claim 9, wherein the forming the bolometer structure includes:
depositing the first metal layer for absorbing infrared light on the sacrificial layer;
forming an insulating layer on the first metal layer;
etching the first metal layer and the insulating layer and forming a predetermined pattern;
depositing a temperature-sensitive resistive layer on the sacrificial layer and the insulating layer;
depositing the second metal layer for infrared light absorption and connection with the metal pad, on the temperature-sensitive resistive layer; and
etching the second metal layer to have a pattern complementary to the pattern of the first metal layer.

11. The method of claim 9, wherein the forming the insulating layer includes forming the insulating layer by oxidizing a surface of the first metal layer.

12. The method of claim 9, further comprising forming a passivation layer on an upper or lower surface of the bolometer structure.

13. The method of claim 9, wherein the depositing the sacrificial layer includes depositing the sacrificial layer to a thickness of 2.5 to 3.0 μm.
